(19) United States
(12) Patent Application Publication
(10) Pub. No.: US 2002/0159850 A1
(43) Pub. Date: Oct. 31, 2002

(54) Countersinking tool for fast-exchange chucks

(76) Inventor: MICHAEL RAVID, M.P. BIKAAT BET HACEREM (IL)

Correspondence Address: SALTAMAR INNOVATIONS, 30 FERN LANE, SOUTH PORTLAND, ME, 04106, US

(21) Appl. No.: 09/958,530

(22) PCT Filed: Jan. 29, 2001
(86) PCT No.: PCT/IL01/00084

(30) Foreign Application Priority Data
Feb. 13, 2000 (IL) 134513

(51) Int. Cl. B23B 51/00

(52) U.S. Cl. 408/226

(57) ABSTRACT

A countersink bit device suitable for quick-exchange chucks, the device comprising a body (4) having distal and proximal sides, said body (4) having a shank of hexagonal cross-section (2) projecting from the body proximal side (4), and two tips (9 and 10) attached to notches provided on said body (4), said tips (9 and 10) projecting from said body (4), presenting cutting edges.

### FIELD OF INVENTION

The present invention relates to countersinking tools. More particularly it relates to a countersinking tool having hexagonal shank for fast-exchange chucks.

### BACKGROUND OF THE INVENTION

A standard drilling machine is usually provided with a chuck for the engagement of drill bits. Drill bits, as well as other types of cutting tools such as router bits, countersinking bits etc. generally comprise a body having cutting blades such as a drill or other cutter flutes on one end, and a shank extending axially from its other end. The shank is received by and engaged to the chuck. Commonly, countersink bits consist of 2-3 elements—body having cutting flutes and a drill bit that serves also as a shank or the shank as a third element—attached together, where the cutting part nor the body are not directly secured to the chuck, and since they are rotated at very high gyration velocities they may disintegrate, posing a safety hazard. Due to the substantial vibrations that such a device is exposed to, its parts may be jettisoned during operation. In addition, commonly available countersink bits are not suitable for processing hard wood and other abrasive materials, such as chipboard, MDF etc. due to the material they are made from, which is usually too soft for the task.

Commonly available power drill chucks are adjustable metal lips that are brought together or withdrawn from each other by screwing or unscrewing a ring over these lips that forces the lips closer or releases them to separate again. The shank of a cutting bit is inserted between the lips and the ring screwed to fasten the lips over the shank holding it firmly in position.

A fast-exchange chuck, aimed at speeding up the process of mounting or exchanging a cutting bit onto a drilling machine, was disclosed in U.S. Pat. No. 4,692,073 (Martindell), filed in 1986. The chuck disclosed in that patent comprises a quick-release chuck having a spindle with a longitudinally extending bore in the spindle adapted to receive the shank of a power bit. A radially extending bore extends through the spindle and communicates with the bore. A ball is disposed in the bore and contacts a portion of the shank of the power bit disposed in the bore. A spring biased sleeve is disposed about the spindle and includes a tapered bore which bears against the ball to bias the ball against the shank of the tool.

Another chuck assembly is disclosed in U.S. Pat. No. 4,900,202 titled CHUCK ASSEMBLY FOR TOOL BITS (Wienhold) and In U.S. Pat. No. 5,013,194 titled CHUCK ASSEMBLY FOR TOOL BITS (Wienhold). The shank of the tool bit is provided with a circumferential groove. The chuck is provided with a spindle with a longitudinal bore, for receiving the shank of the tool bit. The shank is held in place by balls disposed around the shank in an opposing manner, engaged into the circumferencial bore on the shank.

In order to reduce safety hazards, it is beneficial to use a safety chuck mechanism such as the one disclosed in U.S. Pat. No. 5,398,946 “CHUCK HAVING ONE-STEP LOCK AND RELEASE” filed by E. L. Quiring in 1993. This patent discloses a chuck device having a one-step lock and release mechanism for conveniently coupling a power bit to a drill having a Jacob-style chuck. The chuck device includes a body having a centrally-positioned bore which is adapted to receive the power bit shank. The power bit shank includes a circumferentially-extending groove which is positioned inside the bore. The body has an inclined cam channel which includes an aperture for communicating with the bore. The body further includes a longitudinally-extending slot communicating with the inclined cam channel. A detent ball is disposed within the inclined cam channel for partial penetration through the aperture for engaging the circumferentially-extending groove of the power bit shank. A spring having an end encircles the body where the end is slidably positioned within the slot for biasing the detent ball rearwardly along the inclined cam channel during the unlocking and withdraw of the power bit from the chuck device. The position of the spring is confined on the body of the retaining ring positioned proximate to the inclined cam channel and by a sleeve which encircles a portion of the body. The retraction of the sleeve in a rearward direction compresses the spring and rearwardly biases the spring end within the slot for movement of the detent ball from locking engagement to the circumferentially-extending groove. Release of the sleeve permits the expansion of the spring and the biasing of the sleeve and the detent ball in the forward direction for locking engagement to a power bit.

Prior art drilling tools, and in particular countersink bits are usually made from steel. Steel bits wear quite easily, significantly reducing the lifetime of the bits. The lifetime of flutes made from a hard metal such as tungsten carbide, which is used for flutes of cutting tools or router cutters, is much longer. The use of drill and countersink bits made from hard metal increases significantly the efficiency of the drilling tool by rendering it with relatively longer lifetime. Extended lifetime of countersink and drill bits made from hard metal is especially significant when processing hard and abrasive materials such as hard wood, laminated chipboard, MDF and other artificial materials based on resins.

### BRIEF DESCRIPTION OF THE INVENTION

It is the object of the present invention to provide a countersink with hexagonal shank for quick-exchange chucks to be used for woodworking.

It is another object of the present invention to provide a countersink with hexagonal shank for quick-exchange chucks that enables fast exchange of bits quickly and simply, and facilitating comfortable exchange from countersink bits to screwdriver bits or to drill bits having hexagonal shanks and vise versa.

It is another object of the present invention to provide a countersink with hexagonal shank for quick-exchange chucks that enables adjustment of the drill bit length conveniently.

It is another object of the present invention to provide a countersink with hexagonal shank for quick-exchange chucks wherein the hexagonal shank can be locked and released from a power drill chuck using fast-exchange mechanism.

It is another object of the present invention to provide a tungsten carbide tipped countersink with hexagonal shank for quick-exchange chucks to facilitate extended working on hardwoods and abrasive materials such as chipboards, MDF etc.

Yet another object of the present invention is to provide a countersink with hexagonal shank for quick-exchange chucks that is made as a single integrated piece (the shank and the body having cutting flutes) and facilitates mounting and dismounting of a drill bit and adjustment of its height above the tools body.

It is thus provided in accordance with a preferred embodiment of the present invention, a countersink bit device suitable for quick-exchange chucks, the device comprising a body having distal and proximal sides, said body having a shank of hexagonal cross-section projecting from the body proximal side, and two tips attached to notches provided on said body, said tips projecting from said body, presenting cutting edges.

Furthermore, in accordance with a preferred embodiment of the present invention, said body and shank are manufactured as a single integrated piece.

Furthermore, in accordance with a preferred embodiment of the present invention, said tips are made from tungsten carbide.

Furthermore, in accordance with a preferred embodiment of the present invention, said shank is provided with a circumferential groove about said shank.

Furthermore, in accordance with a preferred embodiment of the present invention, said device is further provided with a drill bit inserted and secured in said body's distal side.

Furthermore, in accordance with a preferred embodiment of the present invention, said drill bit is secured in said body by an Allen screw.

Furthermore, in accordance with a preferred embodiment of the present invention, said body is cylindrically shaped.

Furthermore, in accordance with a preferred embodiment of the present invention, said shank is substantially one-quarter inch in its lateral width.

Furthermore, in accordance with a preferred embodiment of the present invention, said shank is adapted to be mounted on a power tool having fast-exchange mechanism chuck.

Furthermore, in accordance with a preferred embodiment of the present invention, said shank is adapted to fit into a chuck of a standard power tool.

Furthermore, in accordance with a preferred embodiment of the present invention, said notches are opposite notches each having a flat surface, and wherein said tips are each attached to said flat surface.

Furthermore, in accordance with a preferred embodiment of the present invention, said tips have the shape of a substantially right-angled trapezoid.

Furthermore, in accordance with a preferred embodiment of the present invention, said tips are rectangular.

### BRIEF DESCRIPTION OF THE FIGURES

In order to better understand the present invention, and appreciate its practical applications, the following Figures are provided and referenced hereafter. It should be noted that the Figures are given as examples only and in no way limit the scope of the invention as defined in the appending claims. Like components are denoted by like reference numerals.

FIG. 1. illustrates a frontal view of a countersink bit with hexagonal shank for quick exchange chucks, in accordance with a preferred embodiment of the present invention.

FIG. 2. illustrates a frontal view of a counterbore bit with hexagonal shank for quick exchange chucks, in accordance with another preferred embodiment of the present invention.

### DETAILED DESCRIPTION OF THE PRESENT INVENTION AND FIGURES

The present invention provides a novel design of a countersink bit with hexagonal shank for quick-exchange chucks, suitable for industry, workshops, craftsmen and do-it-yourself carpenters. This is mainly due to the simplicity of exchanging the bits from countersink bit to screwdriver bit or to drill bit and vice versa. The countersink of the present invention is made as a single piece, the shank permanently connected to the bit's body, thus rendering it extra strength and durability.

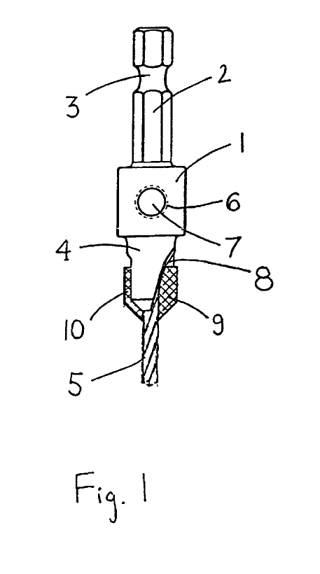

Reference is now made to FIG. 1, illustrating a frontal view of a countersink bit with hexagonal shank for quick-exchange chucks, in accordance with a preferred embodiment of the present invention. The countersink bit's body (designated by numeral 1) is cylindrically shaped. A body having at least 180° symmetry around the rotatory axis is preferable since this fact minimizes the risk of vibrations during rotation. A cylindrically shaped body is even more preferable since it is symmetrical at any angle around the rotatory axis. Body 1, which possesses rotatory symmetry, has distal and proximal sides. Body 1 has a hexagonal shank 2 projecting from the center of the body's proximal side along the symmetry axis of the body. The hexagonal shank is designed to be installed in a power drill chuck (not shown in the figure) of an automated machine that provides rotatory motion to the countersink bit, along its symmetry axis.

A groove 3 is provided about the circumference of hexagonal shank 2. Hexagonal shank 2 preferably conforms the standard size requirements of power tools and thereby is preferably one-quarter inch in its lateral width. Groove 3 is adapted to enable locking and releasing of the shank from a power tool chuck having fast-release mechanism, such as the ones mentioned above. Hexagonal shank 2 can be locked also in a chuck of a regular power tool. The fast-exchange mechanism facilitates multi-functionality of the power tool device.

The distal side of the body 4 is provided with a longitudinal central bore adapted to receive a drill bit 5. Drill bit 5 is inserted into the bore and fastened by a lateral screw, preferably an Allen screw 7 which is screwed in through bore 6. When Ellen screw 7 is screwed in, it secures drill bit 5 and prevents any movements that may occur during rotatory action of the countersink bit.

The countersink body's distal side 4 is provided with opposite notches 8 wherein a flat surface is provided in each one of the notches, each flat surface faces opposite side of the countersink bit. On the flat surfaces, two tips 9, 10 made of a hard metal, preferably tungsten carbide, are attached. One of the tips is attached on one flat surface, and the other tip is attached on the other flat surface. The cutting edges of each one of the blades protrude from the body so that both cutting edges face the material being processed upon rotatory motion of the countersink bit, when it is put into action.

The shape of the blades depends on the purpose of the tool. For countersinking a screw having a head of conical shape, substantially right-angled trapezoid-like tips such as the ones shown in FIG. 1 (tips 9 and 10), provide the necessary profile. The right-angled trapezoid-like tips are attached to the flat surface so that the acute angle of the trapeze points in opposite directions and faces the processed material. The tips are brazed to the tools body in order to render the tool extra strength and durability.

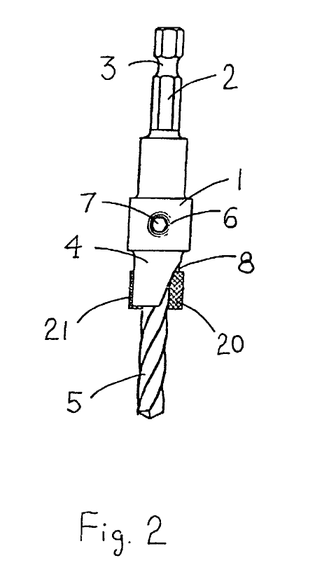

When a bolt with a head of a rectangular cross section needs to be countersunk, a counterbore bit, which is a type of a countersink bit, is used, having substantially rectangular tips. Reference is made to FIG. 2, which illustrates a frontal view of a counterbore bit with hexagonal shank for quick exchange chucks, in accordance with another preferred embodiment of the present invention. tips 20 and 21 are rectangular and provide a counterbore having a flat bottom.

Notches 8 are provided to facilitate the disposal of chips from the cutting surface of tip 9 and also chips that come out from the drilling area.

The replacement of the drill bit 5 is very simple and makes the countersink appealing for industry, workshops, craftsmen and do-it-yourself carpenters.

The fact that the countersink bit of the present invention is made as a single piece (the body and shank) is also very appealing to the industry as it is very simple to use, not vulnerable for disintegration and requires no unnecessary small parts such as screws for the fastening of the body to the shank, as in commonly available countersink bits.

It should be clear that the description of the embodiments and attached Figures set forth in this specification serves only for a better understanding of the invention, without limiting its scope as covered by the following Claims.

It should also be clear that a person skilled in the art, after reading the present specification could make adjustments or amendments to the attached Figures and above described embodiments that would still be covered by the following Claims.

1. A countersink bit device suitable for quick-exchange chucks, the device comprising a body having distal and proximal sides, said body having a shank of hexagonal cross-section projecting from the body proximal side, and two tips attached to notches provided on said body, said tips projecting from said body, presenting cutting edges.

2. The device as claimed in claim 1, wherein said body and shank are manufactured as a single integrated piece.

3. The device as claimed in claim 1, wherein said tips are made from tungsten carbide.

4. The device as claimed in claim 1, wherein said shank is provided with a circumferential groove about said shank.

5. The device as claimed in claim 1, wherein it is further provided with a drill bit inserted and secured in said body's distal side.

6. The device as claimed in claim 1, wherein said body is cylindrically shaped.

7. The device as claimed in claim 1, wherein said shank is substantially one-quarter inch in its lateral width.

8. The device as claimed in claim 1, wherein said shank is adapted to be mounted on a power tool having fast-exchange mechanism chuck.

9. The device as claimed in claim 1, wherein said shank is adapted to fit into a chuck of a standard power tool.

10. The device as claimed in claim 4, wherein said drill bit is secured in said body by an Allen screw.

11. The device as claimed in claim 1, wherein said notches are opposite notches each having a flat surface, and wherein said tips are each attached to said flat surface.

12. The device as claimed in claim 1, wherein said tips have the shape of a substantially right-angled trapezoid.

13. The device as claimed in claim 1, wherein said tips are rectangular.
